(19) United States
(12) Patent Application Publication
(10) Pub. No.: US 2007/0066391 A1
(43) Pub. Date: Mar. 22, 2007

(54) Gaming machine

(75) Inventor: Sakiko Kojima, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE CORP.

(21) Appl. No.: 11/516,675

(22) Filed: Sep. 7, 2006

(30) Foreign Application Priority Data
Sep. 8, 2005 (JP) P2005-261037

(51) Int. Cl. A63F 13/00

(52) U.S. Cl. 463/31

(57) ABSTRACT

A slot machine includes: a reel which variably displays a plurality of symbols; symbol determination means which determines stop symbols to be visibly stopped on a pay line; and symbol display control means which performs a control for visibly stopping the stop symbols on the pay line, wherein a variable display game is played using a variable display and a visible stopping of the plurality of symbols, and a award is paid out in accordance with a combination of the stop symbols. The symbol display control means performs a two-step visible stopping control in which, after an adjacent area W1b adjacent to a central area W1a of a high award symbol is temporarily stopped, the central area is stopped on the pay line, thereby visibly stopping the high award symbol on the pay line.

### CROSS-REFERENCE TO THE RELATED APPLICATION(S)

The present application is based upon and claims priority from prior Japanese Patent Application No. 2005-261037, filed on Sep. 8, 2005, the entire contents of which are incorporated herein by reference.

### TECHNICAL FIELD

The present invention relates to a gaming machine on which a variable display game is played with a mechanical reel.

### BACKGROUND

A variety of types of a slot machine using a mechanical reel (referred to also as a mechanical slot machine) has heretofore been known. For example, there is disclosed in JP-A-9-056873 (U.S. Pat. No. 5,863,249) a slot machine in which a bonus symbol is displayed in a large size. Also, there is disclosed in JP-A-7-096072 a pachinko gaming machine which can be applied to a mechanical slot machine.

In the mechanical slot machine, a plurality of symbols is arranged on an outer periphery of each reel, and the reels are related one-on-one to code numbers, while a code number is determined based on an extracted random number, and a symbol corresponding to the determined code number is visibly stopped on an activated pay line as a stop symbol. Also, in each of the reels, an area in which each of the symbols is depicted is evenly allocated to each of the symbols along a circumferential direction. For this reason, the areas in which the symbols are depicted correspond one-on-one to the code numbers (for example, as shown in FIG. 17A, code numbers “2”, “3” and “4” are related one-on-one to areas r2, r3 and r4).

Meanwhile, in order to display a specific symbol in a larger size than the other symbols using the mechanical reel like the slot machine disclosed in JP-A-9-056873, it is necessary to depict the specific symbol in a large size on the outer periphery of the reel, and thus areas to be related to other symbols adjacent thereto have to be made an area of the specific symbol (for example, as shown in FIG. 17B, the areas r2 and r4 adjacent to the area r3 are also made an area of an enlarged specific symbol “7”). Then, a code number should otherwise be related one-on-one even to an area to be related to a symbol other than the specific symbol but, once the code number is selected, a problem occurs in which the specific symbol projects into the adjacent areas instead of being displayed in the center (for example, as shown in FIG. 17B, the areas r2 and r4 are related to the code numbers “2” and “4”, respectively, but, once the code number “2” or “4” is selected, an upper or lower end of the symbol “7” is visibly stopped on the activated pay line). For this reason, it is necessary to eliminate code numbers to be related to areas adjacent to the specific symbol and prevent the code numbers from being selected by a random number selection (for example, as shown in FIG. 17C, the code numbers “2” and “4” related respectively to the areas r2 and r4 are eliminated).

However, when code numbers are eliminated in this way, the code numbers will not be selected by the random number selection, thus preventing the specific symbol from projecting into the adjacent areas. However, even when the specific symbol is visibly stopped, as with the other symbols, the specific symbol can be visibly stopped only in a predictable and stereotyped mode in which it is displayed while the reel is being gradually reduced in speed.

In general, as a player, who plays a variable display game (referred to also as a slot game) on a slot machine, plays the variable display game while focusing attention on a symbol to be visibly stopped, so long as a specific symbol above all is displayed in a large size, he or she plays the variable display game while hoping that the specific symbol will be visibly stopped. However, in the event that a visible stopping mode is predictable although the specific symbol is displayed in a large size, it confines a gaming thrill to one which can be obtained by displaying the specific symbol in a large size and thereby making it seem to become easier for the player to win, so that a hoped-for gaming thrill becomes unsatisfied.

### SUMMARY

One of objects of the present invention to provide a gaming machine that provides a variable display game using a mechanical reel to be played by a player, with a configuration in which a hoped-for gaming thrill is well fulfilled by displaying a specific symbol in a large size, improving a gaming thrill of the variable display game.

According to a first aspect of the invention, there is provided a gaming machine including: an image display device that has a symbol display area; an operation unit that allows a player to input operations including a start command to start a game; and a processor that performs a game process for providing the player the game by controlling the image display device to display a progress of the game. The processor performs the game process including: controlling the image display device to perform variable display for variably displaying a plurality of symbols in a predetermined sequence in the symbol display area when the start command is input through the operation unit; determining a stop state of the symbol by determining a symbol from among the plurality of symbols to be displayed stopped on a pay line that is configured for determining a win of the game; controlling the image display device to perform stop display of the determined symbol on the pay line in the stop state; and performing a payout of an award to the player in accordance with the stop state. The plurality of symbols include a special display symbol that is to be displayed in a larger size than other symbols by having a central area and two adjacent areas arranged adjacent to the central area, the central area and the adjacent areas being configured to be stoppable on the pay line. The processor performs the game process further including a two-step visible stopping control for controlling the image display device to perform stop display of the special display symbol when the special display symbol is determined to be displayed stopped on the pay line, by controlling the image display device to perform stop display of the central area on the pay line after controlling the image display device to temporary perform stop display of one of the adjacent areas on the pay line.

According to a second aspect of the invention, there is provided a gaming machine for allowing a player to play a variable display game based on a variable display and a stop display of a plurality of symbols and paying out an award responsive to the stopped symbol. The gaming machine includes: a variable display means for variably displaying a plurality of symbols; a symbol determination means for determining a stop symbol from among the plurality of symbols to be displayed stopped on an activated pay line to determine a win; and a symbol display control means for performing stop display of the stop symbol determined by the symbol determination means on the activated pay line. The plurality of symbols include a special display symbol that is to be displayed in a larger size than other symbols by having a central area and two adjacent areas arranged adjacent to the central area, the central area and the adjacent areas being configured to be stoppable on the pay line. When the special display symbol is determined as the stop symbol by the symbol determination means, the symbol display control means performs a two-step visible stopping control in which the special display symbol is visibly stopped on the activated pay line by the central area being stopped on the activated pay line after a temporary stop is performed in which one of the adjacent areas is stopped on the activated pay line.

### BRIEF DESCRIPTION OF THE DRAWINGS

In the accompanying drawings:

FIG. 1 is a perspective view showing an overall configuration of a slot machine according to an embodiment;

FIG. 2 is a front view showing a main display of the slot machine shown in FIG. 1;

FIG. 3 is a front view showing a configuration of reels;

FIG. 4 is a perspective view showing one of the reels shown in FIG. 3;

FIG. 5 is a perspective view showing a schematic configuration of a liquid crystal display device as seen from a back of a cabinet;

FIG. 6 is an exploded perspective view of a portion of the liquid crystal display device;

FIG. 7 is a block diagram showing mainly an internal configuration of the slot machine according to the embodiment;

FIG. 8 is a block diagram showing an image control circuit;

FIG. 9 is a flowchart showing an operation procedure of a main process ranging from a start to a finish of a game on the slot machine according to the embodiment;

FIG. 10 is a flowchart showing an operation procedure of a selection process;

FIG. 11 is a flowchart showing an operation procedure of a base game process;

FIG. 12 is a flowchart showing an operation procedure of a stop control process;

FIG. 13 is a diagram showing an example of details of a stop table;

FIG. 14 is a diagram showing an example of details of a stop symbol determination table;

FIGS. 15A and 15B are front views of the main display showing a condition in which a high award symbol is nudged;

FIG. 16 is a front view showing a configuration of reels in a modified example; and

FIGS. 17A-17C are views schematically showing a relationship between symbols depicted on an outer periphery of a reel and code numbers related to the symbols in an existing slot machine.

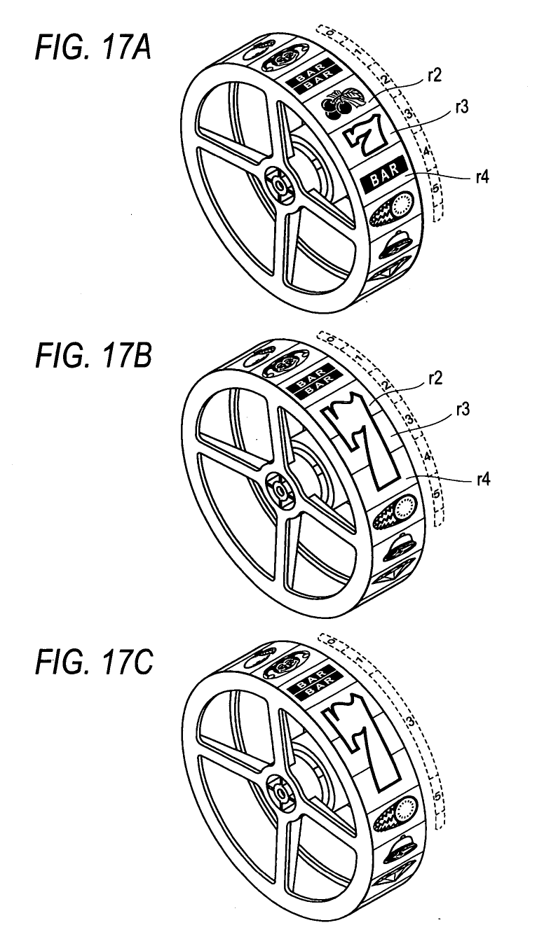

### DETAILED DESCRIPTION

A gaming machine according to an embodiment of the invention will be described with reference to the drawings. In the description, the same references are used for identical components or components having the same function, and a redundant description will be omitted.

In the embodiment, the following slot machine 1 will be described as an example in which the invention is applied to a gaming machine having a reel unit 5 serving as the variable display means of the invention which performs a variable display of a plurality of symbols by means of mechanical reels. The slot machine 1 requires an insertion of a coin at a start of a game.

Overall Configuration of Slot Machine

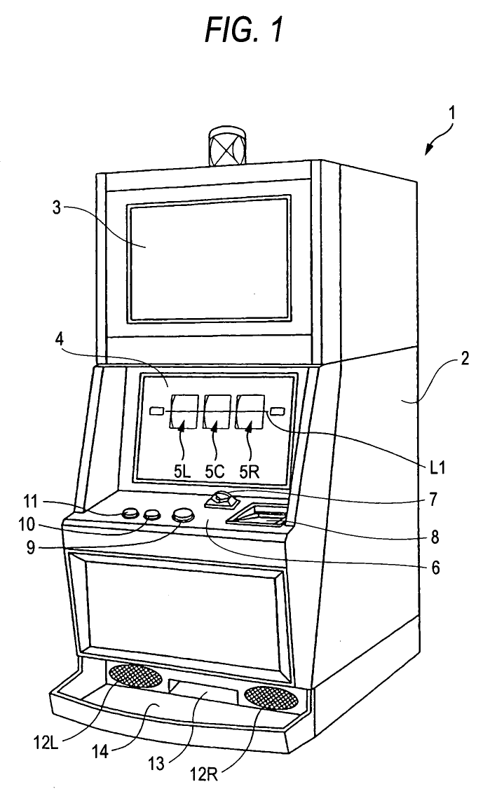

First, an overall configuration of the slot machine 1 will be described with reference to FIG. 1. FIG. 1 is a perspective view showing the overall configuration of the slot machine according to the embodiment.

The slot machine 1 has a sub-display 3 and a main display 4, in order from a top, on a front side of a cabinet 2. The main display 4, being disposed in an approximate vertical center of the cabinet 2, has the reel unit 5 in which three mechanical reels 5L, 5C and 5R are rotatably aligned in horizontal side-by-side relation inside the cabinet 2 in such a way as to correspond to the main display 4.

The reels 5L, 5C and 5R can be visually perceived from an exterior through symbol display areas 21L, 21C and 21R to be described hereafter. The reels 5L, 5C and 5R, details of which will be described hereafter, each having a plurality of kinds of symbols depicted on an outer periphery, are made rotatable in such a way that each of the symbols are variably displayed, and rotate at a fixed speed (for example, 80 revolutions per minute).

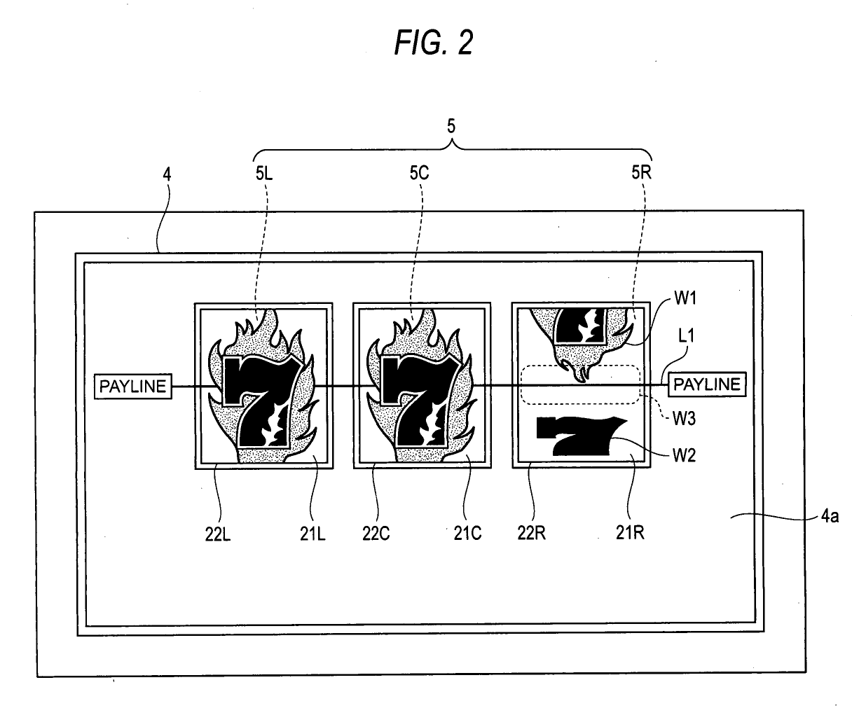

The symbol display areas 21L, 21C and 21R corresponding to the reels 5L, 5C and 5R, as shown in FIG. 2, are provided with one pay line L1 extending horizontally. Although not shown, in addition to the pay line L1, it is acceptable to provide other pay lines, one each, above and below it, in which case it is also acceptable to further provide two diagonal pay lines. When providing a plurality of pay lines, it is preferable to configure in such a way that a number of pay lines varies according to a number of coins inserted. In this case, each of the play lines is configured in such a way as to be activated in response to the number of coins inserted and an operation of BET switches 10 and 11 to be described hereafter. The pay line L1 activated is referred to also as an “activated pay line” or simply as a “pay line”. When a player inserts one coin into a coin insertion slot 7 to be described hereafter, only the central pay line L1 is activated then, when the player inserts two coins, upper and lower pay lines are added to the play line L1 and, when the player inserts three coins, all the pay lines are activated.

Also, the slot machine 1 has an approximately horizontal operation panel 6 provided below the main display 4. The operation panel 6 is provided with the coin insertion slot 7, a bill insertion slot 8, a SPIN switch 9, a 1-BET switch 10 and a MAX-BET switch 11.

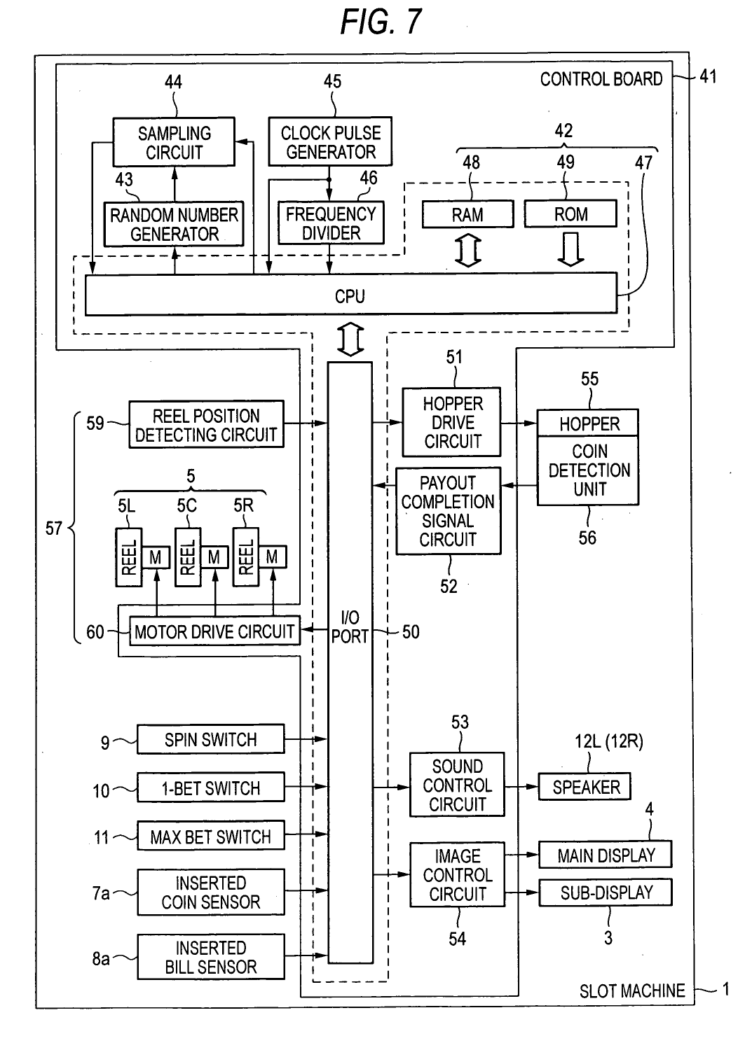

The coin insertion slot 7, being provided for the player to insert a coin to be bet on the game, has an inserted coin sensor 7a (refer to FIG. 7) which transmits a signal indicating the coin insertion. Also, the bill insertion slot 8, being provided for the player to insert a bill, has an inserted bill sensor 8a which transmits a signal indicating the bill insertion. The SPIN switch 9 is provided so as to start a variable display of the symbols as the reels 5L, 5C and 5R rotate in the symbol display areas 21L, 21C and 21R, that is, provided for the player to perform an operation to start a slot game. The 1-BET switch 10 is provided for the player to perform a setting to bet one coin by one operation of the 1-BET switch 10. The MAX-BET switch 11 is provided so as to perform a setting to bet a maximum number of coins which can be bet on one game, by one operation of the MAX-BET switch 11.

Furthermore, the slot machine 1 is provided, in a bottom of the cabinet 2, with speakers 12L and 12R, a coin payout opening 13 positioned sandwiched between the speakers 12L and 12R, and a coin receiving tray 14 which receives the coin paid out through the payout opening 13.

Description of Each Display

As shown in FIG. 2, the main display 4 has the symbol display areas 21L, 21C and 21R, window frame display areas 22L, 22C and 22R, and an effect display area 4a. Display details of the main display 4 are configured in such a way as to vary according to a variable display state and stop state of each of the reels 5L, 5C and 5R, and to operation details of the slot machine 1.

The symbol display areas 21L, 21C and 21R, being provided corresponding to the reels 5L, 5C and 5R, are areas for visibly displaying the symbols depicted on the reels 5L, 5C and 5R. In the symbol display areas 21L, 21C and 21R, in a case in which the corresponding reels 5L, 5C and 5R are rotating and in a case in which they stop rotating, a visible display is used which allows the player to visually perceive the symbols depicted on each of the reels 5L, 5C and 5R.

The window frame display areas 22L, 22C and 22R, being provided in such a way as to surround the corresponding symbol display areas 21L, 21C and 21R, function as display windows of the symbols depicted on each of the reels 5L, 5C and 5R.

Also, an effect for increasing player's interest, and information for the player to favorably progress the game, are displayed in the effect display area 4a.

The sub-display 3 is configured in such a way that the display details vary according to the operation details of the slot machine 1.

Configuration of Reels

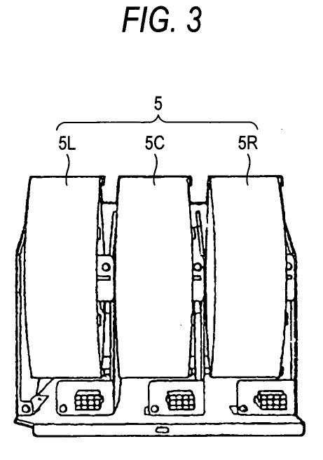

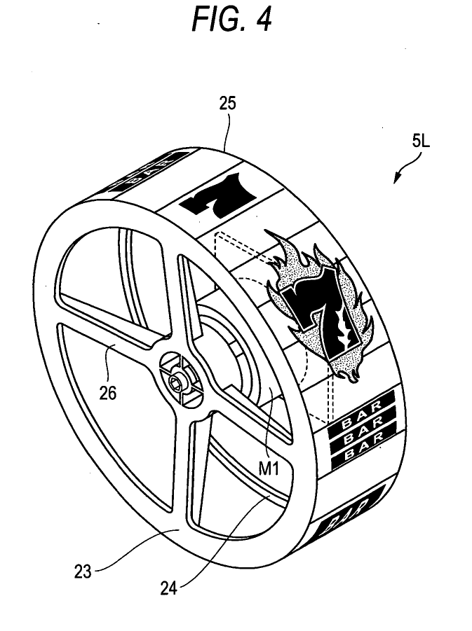

Next, a configuration of the reels 5L, 5C and 5R will be described with reference to FIGS. 3 and 4. FIG. 3 is a front view showing a. configuration of each reel, and FIG. 4 is a perspective view showing one of the reels shown in FIG. 3.

The reels 5L, 5C and 5R, being aligned in horizontal side-by-side relation as shown in FIG. 3, are each configured in such a way as to be able to rotate. The reel 5L, as shown in FIG. 4, as well as having two circular frames 23 and 24 of the same shape spaced a prescribed distance away from one another, has a cylindrical shape formed by connecting the circular frames 23 and 24 via a reel sheet 25 attached to the circular frames 23 and 24. Also, the reel 5L is configured in such a way as to rotate as a driving force of a stepping motor Ml (refer to FIG. 7) disposed inside the reel 5L is transmitted to the circular frame 23 via a transmission member 26 integrally formed with the circular frame 23.

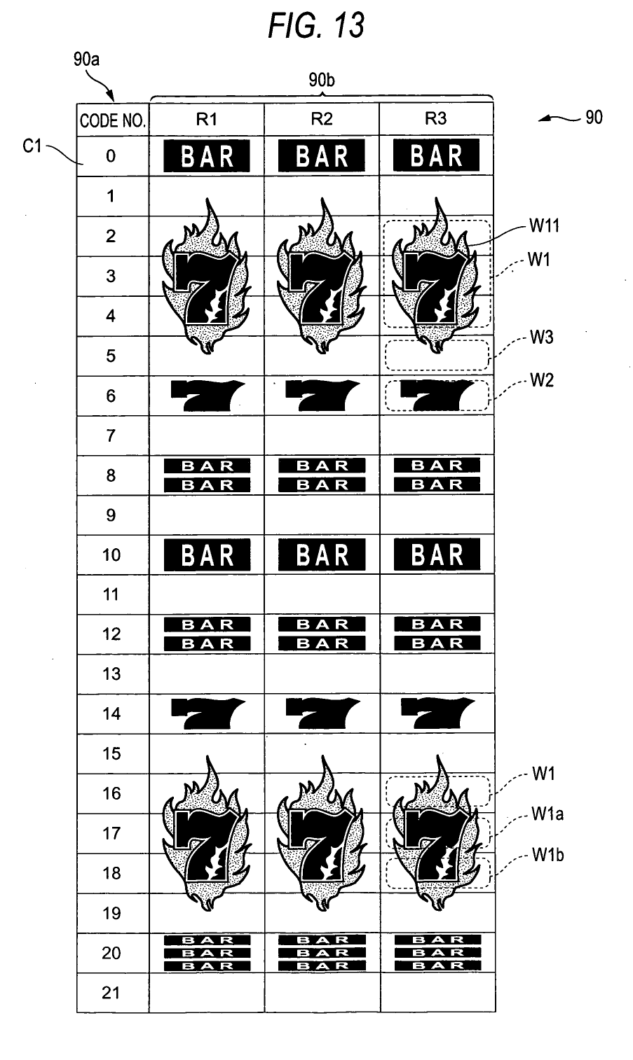

Symbol columns R1 to R3, in which a plurality of symbols corresponding to those of a stop table 90 shown in FIG. 13 are arranged in a reel revolution direction, are each depicted on the reel sheet 25 in such a way as to correspond to each of the reels 5L, 5C and 5R. Although FIG. 13 shows details of the stop table 90 to be described hereafter, a description will be given, with reference to FIG. 13, of the symbol columns R1 to R3 depicted on the reels 5L, 5C and 5R. The symbol columns R1 to R3 are depicted on the respective reels 5L, 5C and 5R. A plurality of symbols is depicted in the symbol columns R1 to R3 in the order shown in the columns R1 to R3 of FIG. 3. The symbol columns R1 to R3 each include a high award symbol W1 (the special display symbol), a high award symbol W2 and a blank symbol W3. The high award symbols W1 indicate that a highest award (for example, a payout of 1199 coins) is allocated by their being visibly stopped aligned on the activated pay line L1. The high award symbols W2 indicate that, when they are visibly stopped aligned on the activated pay line L1, a award (for example, a payout of 300 coins) is allocated which is lower than but next highest to the high award symbols W1. The blank symbols W3 indicate that no award is allocated even though they are visibly stopped on the activated pay line L1. Then, each of the symbol columns R1 to R3 has a three in succession arrangement structure in which the high award symbol W1 and the high award symbol W2 are arranged adjacent to the blank symbol. In the event that both the high award symbol W1 and the high award symbol W2 are visibly stopped on the activated pay line L1, a award (for example, a payout of 200 coins) is allocated which is lower than but next highest to the high award symbols W2.

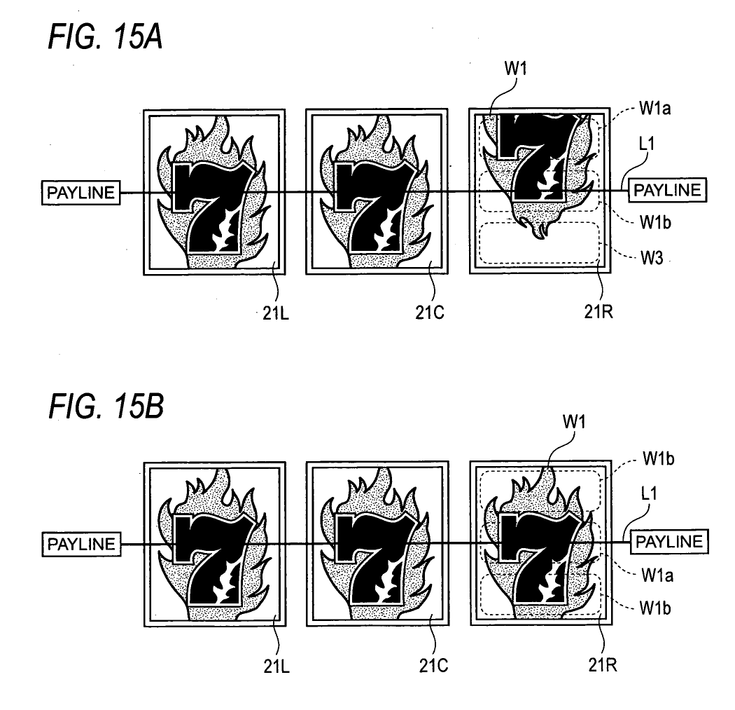

At this point, the high award symbol W1, being a symbol which includes as its picture a number “7” with a flame W11 at the back, is depicted in about three times as large a size as the other symbols. The high award symbol W1, as shown in FIG. 13, has a central area W1a, which displays a center portion of the picture, and two adjacent areas W1b which, as well as being disposed adjacent to the central area W1a, display an upper third and a lower third of the number “7” with the flame W11. An upper end and a lower end of the flame W11 are depicted in such a way as to project slightly into the blank symbols W3 adjacent to the high award symbol W1. Also, the high award symbol W2 is a symbol with a number “7” as its picture. Furthermore, the blank symbol W3 is a symbol including a blank display portion with no picture displayed in it. When the high award symbol W1 is being visibly stopped on the pay line L1, as the high award symbol W1 is larger in size than the other symbols, as shown in FIG. 15B, only the high award symbol W1 is displayed in each of the symbol display areas 21L, 21C and 21R. In contrast, when any symbol other than the high award symbol W1 is being visibly stopped on the pay line L1, for example, as shown in FIG. 2, three symbols are displayed in tandem in the symbol display area 21R while, when the adjacent area W1a of the high award symbol W1 is being temporarily displayed on the pay line L1 (details will be described hereafter), for example, as shown in FIG. 15A, a portion of the high award symbol W1 and the blank symbol W3 are displayed in tandem in the symbol display area 21R (the same also applies to the symbol display areas 21L and 21C).

Description of Liquid Crystal Display

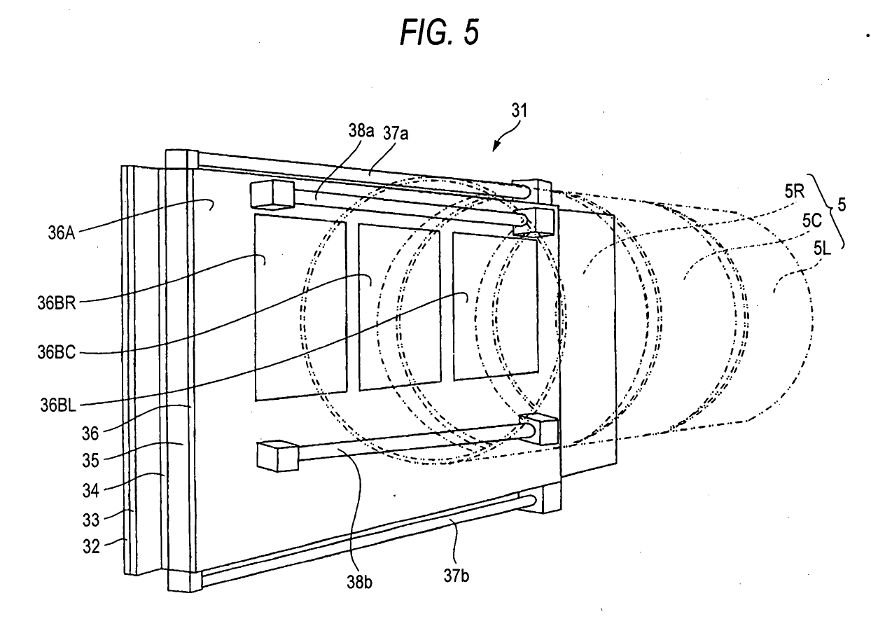

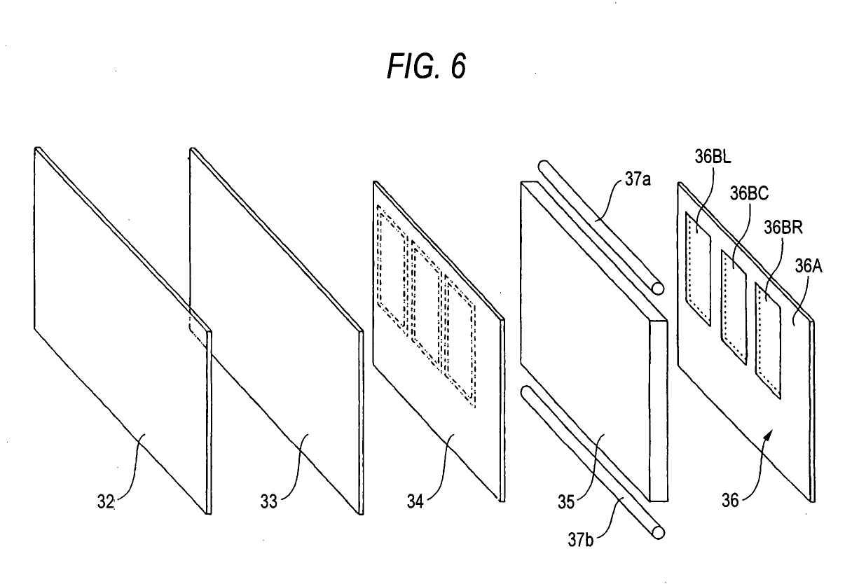

Next, a liquid crystal display device 31 included in the main display 4 will be described with reference to FIGS. 5 and 6. FIG. 5 is a perspective view showing a schematic configuration of the liquid crystal display device as seen from a back of the cabinet. FIG. 6 is an exploded perspective view of a portion of the liquid crystal display device.

The liquid crystal display device 31, straddling the reels 5L, 5C and 5R, is provided in front of the reels 5L, 5C and 5R, being spaced a prescribed distance away from them. The liquid crystal display device 31 has a translucent protective glass 32 and display plate 33, a liquid crystal panel 34, a light guide plate 35, a reflecting film 36, fluorescent lamps 37a, 37b, 38a and 38b which are white light sources, and a flexible board (not shown) made up of a table carrier package (TCP) which, being connected to a terminal of the liquid crystal panel 34, mounts an IC for use in driving the liquid crystal panel 34.

The symbol display areas 21L, 21C and 21R are formed in the liquid crystal panel 34. The liquid crystal panel 34 is configured in such a way that the symbols depicted on each of the reels 5L, 5C and 5R can be visually perceived through the symbol display areas 21L, 21C and 21R, and that the slot game can be played by visually perceiving a variable display and a visible stopping of each of the reels 5L, 5C and 5R. The light guide plate 35, having transparency, is disposed at a back of the liquid crystal panel 34, being provided so as to guide light from the fluorescent lamps 37a and 37b to the liquid crystal panel 34.

The reflecting film 36 is provided so as to reflect the light guided into the light guide plate 35 toward a surface of the light guide plate 35. The reflecting film 36 has a reflective area 36A and non-reflective areas 36BL, 36BC and 36BR. The reflective area 36A reflects incident light, and operates as illumination means which illuminates mainly an area of the liquid crystal panel 34 which corresponds to the window frame display areas 22L, 22C and 22R and the effect display area 4a. The non-reflective areas 36BL, 36BC and 36BR, being formed in such a way as to correspond to the symbol display areas 21L, 21C and 21R, are disposed in front of stop symbols visibly stopped when the reels 5L, 5C and 5R stop rotating.

The fluorescent lamps 37a and 37b emit light to be guided into the light guide plate 35, and operate as the illumination means which illuminates mainly an area of the liquid crystal panel 34 which corresponds to the window frame display areas 22L, 22C and 22R and the effect display area 4a. The fluorescent lamps 38a and 38b operate as illumination means, which illuminates the symbols arranged on each of the reels 5L, 5C and 5R, and illumination means which illuminates an area of the reflecting film 36 which corresponds to the symbol display areas 21L, 21C and 21R.

Internal Configuration of Slot Machine

FIG. 7 is a block diagram of the slot machine 1, showing mainly its internal configuration. The slot machine 1 has a plurality of components around a control board 41. The control board 41 has a microcomputer 42, a random number generator 43, a sampling circuit 44, a clock pulse generator 45 and a frequency divider 46.

The microcomputer 42 has a CPU (Central Processing Unit) 47, an RAM (Random Access Memory) 48 and an ROM (Read Only Memory) 49. The CPU 47, while operating as the selection means, symbol determination means and symbol display control means of the invention in accordance with a program stored in the ROM 49, controls a drive of the whole slot machine 1 by receiving and transmitting a signal with respect to the other components via an I/O port 50. The RAM 48 stores data and a program which the CPU 47 uses when it operates. That is, the RAM 48, as well as holding random numbers, which are sampled by the sampling circuit 44 to be described hereafter, temporarily after the game starts, stores, for example, code numbers of the reels 5L, 5C and 5R which correspond to the sampled random numbers. The ROM 49, as well as storing a to-be-described stop table 90 and stop symbol determination table 91 which, serving as the symbol code storage means, include the code numbers (the symbol codes), stores a program to be executed by the CPU 47 and permanent data.

The random number generator 43 operates in accordance with a command from the CPU 47 and generates a fixed range of random numbers. The sampling circuit 44, in accordance with a command from the CPU 47, extracts an arbitrary random number from among the random numbers generated by the random number generator 43, and transmits the extracted random number to the CPU 47. The clock pulse generator 45 generates a reference clock for causing the CPU 47 to operate, and the frequency divider 46 transmits a signal, which it obtains by dividing the reference clock by a fixed frequency, to the CPU 47.

The control board 41 has a hopper drive circuit 51, a payout completion signal circuit 52, a sound control circuit 53 and an image control circuit 54.

The hopper drive circuit 51 drives a hopper 55 in accordance with a control by the CPU 47. The hopper 55, by performing a coin payout operation, pays out coins through the payout opening 13.

The payout completion signal circuit 52 receives number-of-coins value data from a coin detection unit 56 connected thereto and, when the number-of-coins value reaches a set number-of-coins value, transmits to the CPU 47 a signal notifying it of a coin payout completion. The coin detection unit 56 measures a number of coins paid out by the hopper 55, and transmits the measured number-of-coins value data to the payout completion signal circuit 52.

The sound control circuit 53 receives a command from the CPU 47, and controls a sound signal for outputting a sound from speakers 12L and 12R, causing the sound to be outputted from the speakers 12L and 12R. By this means, for example, a sound for boosting the game is output from the speakers 12L and 12R at an appropriate time after the game starts.

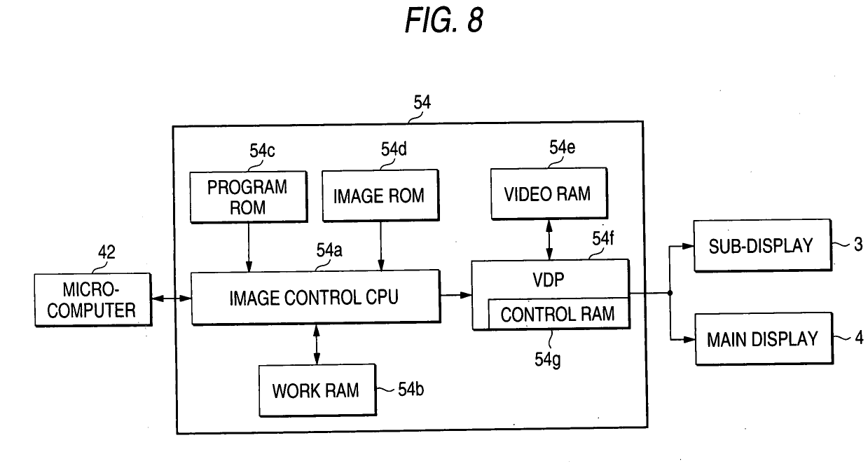

The image control circuit 54 controls an image display in each of the sub-display 3 and the main display 4. As shown in FIG. 8, the image control circuit 54 has an image control CPU 54a, a work RAM 54b, a program ROM 54c, an image ROM 54d, a video RAM 54e and a VDP (Video Display Processor) 54f.

The image control CPU 54a, based on a parameter set in the microcomputer 42, in accordance with an image control program (related to the display in the sub-display 3 and the main display 4) stored in advance in the program ROM 54c, determines images to be displayed on the sub-display 3 and the main display 4. The work RAM 54b is configured as temporary storage means when the image control CPU 54a executes the image control program. The program ROM 54c stores the image control program, various selection tables and the like. The image ROM 54d stores dot data for forming an image. The video RAM 54e is configured as the temporary storage means when the VDP 54f forms an image. The VDP 54f, having a control RAM 54g, forms images corresponding to display details of the sub-display 3 and the main display 4 which have been determined by the image control CPU 54a, and transmits the formed images to the sub-display 3 and the main display 4, causing the displays 3 and 4 to display the transmitted images thereon.

A reel drive unit 57 has a reel position detecting circuit 59, which detects positions of the reels 5L, 5C and 5R, and a motor drive circuit 60 which transmits drive signals to motors M1, M2 and M3 for rotating the reels 5L, 5C and 5R. By receiving the drive signals from the motor drive circuit 60, the motors M1, M2 and M3 are operated so as to rotate the reels 5L, 5C and 5R.

The control board 41 is connected to and receives signals from each of the inserted coin sensor 7a, the inserted bill sensor 8a, the SPIN switch 9, the 1-BET switch 10 and the MAX-BET switch 11.

Operation Details of Slot Machine

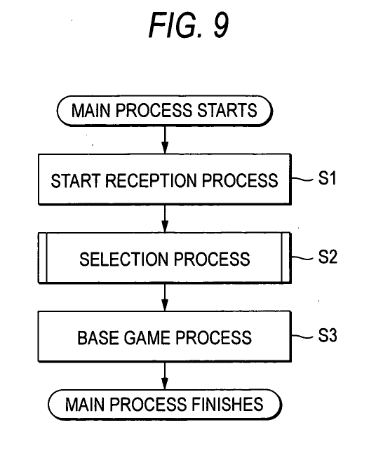

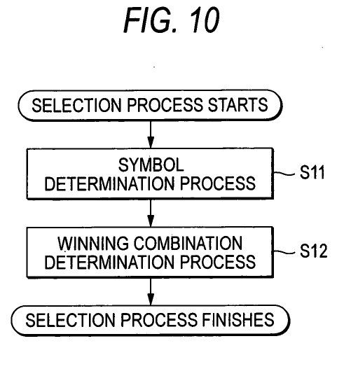

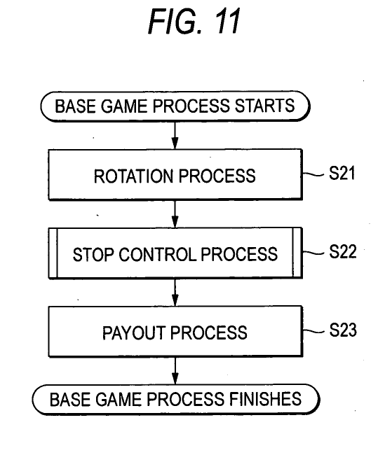

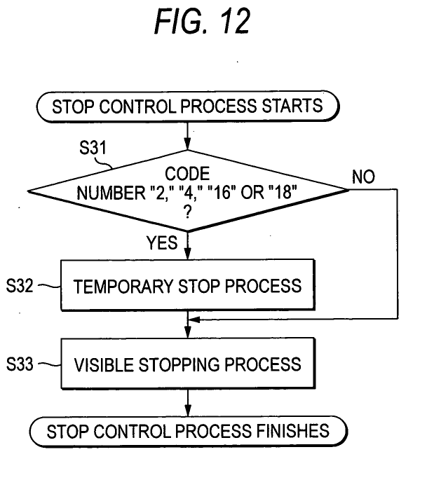

Next, operation details of the slot machine 1 having the above configuration will be described with reference to the flowcharts shown in FIGS. 9 to 12. FIG. 9 is a flowchart showing an operation procedure of a main process from a start to a finish of the game on the slot machine according to the embodiment. FIG. 10 is a flowchart showing an operation procedure of a selection process. FIG. 11 is a flowchart showing an operation procedure of a base game process. FIG. 12 is a flowchart showing an operation procedure of a stop control process. In FIGS. 9-12, a step is abbreviated to S.

In the slot machine 1, when the main process (game process) shown in FIG. 9 starts, a start reception process S1, the selection process S2 and the base game process S3 are performed sequentially in steps 1 to 3, and then the main process finishes. Hereafter, a description will be given of details of each block.

First, the process proceeds to step S1, in which the start reception process is performed when a start command is input by the player. That is, the player inserts a desired number of coins into the coin insertion slot 7 and, when having credits left, operates the 1-BET switch 10 or the MAX-BET switch 11, whereby the start command is input. Subsequently, the player performs an operation of the SPIN switch 9 (hereafter, these operations will be referred to as a “start operation”). By the start operation, a start signal is transmitted from the SPIN switch 9 to the CPU 47.

Next, the process proceeds to step 2, in which the selection process is performed. After the selection process is performed, the process proceeds to step S11 shown in FIG. 10, in which a symbol determination process is performed by the CPU 47. In the symbol determination process, by receiving the start signal, the CPU 47 operates as the symbol determination means, and determines a symbol to be visibly stopped on the pay line L1 for each of the reels 5L, 5C and 5R. It is also acceptable that, during the selection process, the CPU 47 instructs the image control circuit 54 to cause the sub-display 3 and the main display 4 to perform a game effect display.

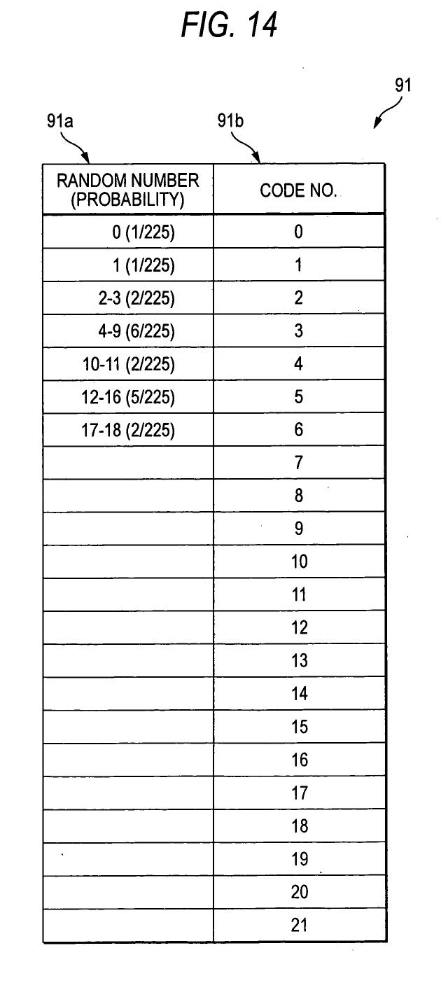

In the symbol determination process, specifically, when detecting the player's start operation based on the start signal from the SPIN switch 9, in response to the detection (that is, in the wake of the start of the slot game), the CPU 47 instructs the random number generator 43 to generate a fixed range of random numbers (in the embodiment, 0 to 254). Also, the CPU 47 instructs the sampling circuit 44 to extract an arbitrary random number from among the random numbers generated by the random number generator 43. When the random number is extracted by the sampling circuit 44, the CPU 47 operates as the selection means of the invention, sets the random number as a search key and, by referring to the stop symbol determination table (a table storing symbol code numbers and random numbers related to each other) 91, selects and obtains a corresponding symbol code number (FIG. 14 illustrates a partially omitted range of random numbers) As used herein, the stop symbol determination table 91 refers to a table which, as shown in FIG. 14, has a symbol code number area 91b storing the symbol code numbers and a random number area 91a storing the random numbers ranging from 0 to 254 related to the symbol code numbers. That is, a probability, with which a symbol is visibly stopped on the pay line L1 as a stop symbol, is determined by a range of random numbers related to a code number of the symbol.

Next, the CPU 47 sets the obtained code number as the search key and, by referring to the stop table 90 stored in the ROM 49, which is the symbol code storage means of the invention, determines a stop symbol for each of the reels 5L, 5C and 5R. As used herein, the stop table 90 refers to a table which, as shown in FIG. 13, has a code number area 90a storing symbol code numbers and a symbol area 90b storing symbols corresponding to the code numbers, being configured in such a way that, by setting a code number as the search key and searching the code number area 90a, it is possible to retrieve the corresponding symbol for each of the reels 5L, 5C and 5R. A plurality of symbols, which is depicted on the reel sheet 25 attached to each of the reels 5L, 5C and 5R for each of the symbol columns R1 to R3, is registered in the symbol area 90b. Then, of the plurality of symbols registered, each symbol (for example, “7” or “BAR”) except the high award symbol W1, and the central area W1a and two adjacent areas W1b of the high award symbol W1, are individually registered in such a way that their code numbers correspond one-on-one to each other. For example, in the central area W1a of the high award symbol W1, a code number “3” is related to “17” and, in the adjacent areas W1b of the high award symbol W1, code numbers “2” and “4” are related to “16” and “18”, respectively. In the event that any one of the code numbers “2”, “4”, “16” and “18”, which is related to the adjacent area W1b of the high award symbol W1, has been selected in the symbol determination process of step S11, a two-step visible stopping control to be described hereafter is performed in a symbol column of the selected code number.

Then, in the slot machine 1, such a random number selection and searching of the stop symbol determination table 91 and the stop table 90 are performed a total of three times, once for each of the reels 5L, 5C and 5R. That is, the searching of each of the tables 90 and 91 is performed a number of times corresponding to a number of reels. Then, when a stop symbol is determined for each of the reels 5L, 5C and 5R, a reel stop position in which to stop each reel on the pay line L1 is determined corresponding to the stop symbol.

When the reel stop position is determined, subsequently, the process proceeds to a winning combination determination process in step S12. In the winning combination determination process, the CPU 47, by referring to a not-shown winning combination determination table (a table in which a winning combination of symbols and a non-winning combination of symbols are distinguishably registered, being related to a combination of code numbers (hereafter referred to as a “code number pattern”)) stored in the ROM 49, determines whether or not a winning combination is established, using the code number pattern. In the event that a code number used in the winning combination determination process is any one of “2”, “4”, “16” and “18” which is related to the adjacent area W1b of the high award symbol W1, by performing the two-step visible stopping control to be described hereafter, the high award symbol W1 is visibly stopped on the pay line L1, and it is determined whether or not a winning combination is established, based not on these numbers but instead on the code number “3” or “17” related to the central area W1a of the high award symbol W1. Subsequently, the CPU 47 refers to a not shown state table stored in the ROM 49 and, when a winning combination has been established, determines a winning state (the “winning state” is referred to also as the “winning combination”). The state table is for determining a winning state, and a award corresponding to each winning state is registered therein.

Next, when the process proceeds to step 3 to start the base game process, the slot game is performed. Then, the process proceeds to step 21 shown in FIG. 11, in which a rotation process is executed. That is, the CPU 47 instructs the motor drive circuit 60 to operate the motors M1, M2 and M3. Then, the reels 5L, 5C and 5R rotate at a fixed speed for a fixed time.

Next, the process proceeds to step 22, in which the stop control process is performed. After the stop control process is performed, the process proceeds to step 31 shown in FIG. 12, in which it is determined whether or not the code number selected in the symbol determination process of step S11 is any one of “2”, “4”, “16” and “18”. If the code number is any one of “2”, “4”, “16” and “18”, the process proceeds to step 32 and, if not, the process proceeds to step 33 without executing step 32. At this time, when the process proceeds to step 32, a temporary stop process is performed in which a reel is temporarily stopped in such a way that the adjacent area W1b of the high award symbol W1 appears on the pay line L1 as shown in FIG. 15A. Subsequently, when the process proceeds to step 33, the CPU 47 operates again as the symbol display control means of the invention, moves a reel in such a way as to shift (nudge) the adjacent area W1b temporarily stopped on the pay line L1, and stops the central area W1a on the pay line L1, thereby visibly stopping the high award symbol W1 on the pay line L1 (refer to FIG. 15B). Then, after step 33 is executed, the stop control process finishes. That is, when a code number corresponding to the adjacent area W1b of the high award symbol W1 has been selected in the symbol determination process of step S11, the heretofore described steps 32 and 33 are executed. In steps 32 and 33, the CPU 47 operates as the symbol display control means of the invention, and instructs the motor drive circuit 60 to perform the two-step visible stopping control of the reels 5L, 5C and 5R. Contrarily, if the code number selected in the symbol determination process of step S11 is other than “2”, “4”, “16” or “18”, the process proceeds to step 33 without executing step 32. In step 32, the CPU 47 operates as the symbol display control means of the invention, and instructs the motor drive circuit 60 to stop the reels 5L, 5C and 5R in such a way that the stop symbol determined in the symbol determination process of step S11 appears and is visibly stopped. In the slot machine 1, the reels 5L, 5C and 5R are stopped in the order named (in the order of left, center and right). Then, when the stop control process finishes, the process proceeds to a payout process of step 23. In step 23, if it is determined, in the winning combination determination process of step S12, that the winning combination has been established, the CPU 47 instructs the hopper drive circuit 51 to drive the hopper 55 and, after a number of coins equivalent to a award corresponding to the winning state is paid out, the main process finishes.

As described heretofore, in the embodiment, one of a plurality of code numbers, which are individually related to each symbol except the high award symbol W1 and to the central area W1a and adjacent areas W1b of the award symbol W1, is selected by the random number selection. Then, when the selected code number corresponds to the adjacent area W1b of the high award symbol W1, the two-step visible stopping control is performed in which the central area W1a is stopped on the pay line after the adjacent area W1b is temporarily stopped on the pay line L1. Contrarily, when the selected code number does not correspond to the adjacent area W1b, a symbol corresponding to the code number is visibly stopped on the pay line L1 without performing the two-step visible stopping control. For this reason, as the high award symbol W1 displayed in a larger size than the other symbols is visibly stopped in such a way as to stop in two steps, while the other symbols are simply visibly stopped, the high award symbol W1 is stopped from being predictable in the visibly stopped state. Furthermore, a period of time before the high award symbol W1 is visibly stopped becomes longer than a period of time before the other symbols are visibly stopped, making it easier to raise a player's hope. Then, while the player is being made to think, by the temporary stop of the adjacent area W1b, that it is impossible to win a high award because the hoped-for high award symbol W1 has not been visibly stopped, the reel moves again afterward, the central area W1a is stopped, and the high award symbol W1 is visibly stopped. Therefore, it is possible to make the player feel as if a winning of the high award, which he or she has been on the point of giving up on, were realized. For this reason, it is possible to increase a joy of winning the high award as compared with the case of the simple visible stopping, and to make the player feel as if he or she were lucky or gained a profit and, with a configuration in which a hoped-for gaming thrill is well fulfilled by displaying the high award symbol W1 in a larger size than the other symbols, it is possible to improve a gaming thrill of the slot game.

Also, in the embodiment, when performing the two-step visible stopping control, the central area W1a is visibly stopped on the pay line by shifting (nudging) the adjacent area W1b temporarily stopped on the pay line to the central area W1a, thereby visibly stopping the high award symbol W1 on the pay line L1. For this reason, as it becomes possible to visually perceive a condition (a nudged condition) in which the special display symbol is visibly stopped on the pay line by the adjacent area being temporarily visibly stopped and thereafter shifted to the central area, it is possible to raise a hope a watching player has for a winning combination.

Although a detailed description has been given so far of a preferred embodiment of the invention and its modified example, the invention is not limited to the heretofore described embodiment or modified example. For example, in the embodiment, a configuration is such that, in the event that any one of the code numbers “2”, “4”, “16” and “18”, which is related to the adjacent area W1b of the high award symbol W1, has been selected, the two-step visible stopping control is performed in a symbol column from which the code number has been selected, of the symbol columns R1 to R3 each depicted on the reel sheet 25 attached to each of the reels 5L, 5C and 5R. However, it is sufficient to perform the two-step visible stopping control in at least a last symbol column to be lastly stopped of the symbol columns, and it is also acceptable to configure in such a way that, for example, the other symbol columns each have the high award symbol W1 provided with no adjacent areas W1b, and thus that no two-step visible stopping control is performed in the other symbol columns. Also, more preferably, it is sufficient to perform the two-step visible stopping control in at least the symbol column R3 (the rightmost symbol column) allotted to the reel 5R disposed on the rightmost position as one faces the slot machine 1 and, for example, in such a way as heretofore described, the two-step visible stopping control does not have to be performed in the other symbol columns R1 and R2. It is the symbol column R3 allotted to the reel 5R in which the symbol visible stopping is lastly performed on the slot machine 1 and, as the player plays the variable display game while focusing greatest attention on a symbol to be visibly stopped in the rightmost symbol column, it is possible to more effectively fulfill a function of the two-step visible stopping control.

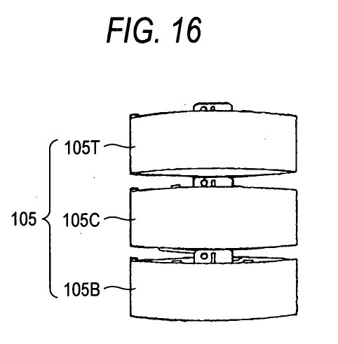

Although, in the embodiment, the slot machine 1 has the reel unit 5 with the reels 5L, 5C and 5R aligned in horizontal side-by-side relation, as shown in FIG. 16, it is also acceptable that the slot machine 1 has a reel unit 105 with reels 105T, 105C and 105B aligned in vertical side-by-side relation. In this case as well, it is sufficient to perform the two-step visible stopping control in at least a last symbol column to be lastly stopped, of symbol columns each depicted on a reel sheet attached to each of the reels 105T, 105C and 105B, and it is also acceptable to configure in such a way that, for example, in such a way as heretofore described, no two-step visible stopping control is performed in the other symbol columns.

In the embodiment, when performing the two-step visible stopping control, by shifting (nudging) the adjacent area W1b temporarily stopped on the pay line L1 to the central area W1a, the central area W1a is stopped on the pay line, and the high award symbol W1 is visibly stopped on the pay line L1, but the invention is not limited to this. It is also acceptable that, for example, after the adjacent area W1b is temporarily stopped, the CPU 47 instructs the motor drive circuit 60 to rotate the relevant reel once or a plurality of times (that a reel, after being temporarily stopped, is rotated again is referred to also as a “re-spin”), and the central area W1a is then visibly stopped on the pay line L1.

In the embodiment, when the high award symbols W1 are visibly stopped aligned on the pay line L1, a highest award is allocated, but the invention is not limited to this. For example, it is also acceptable to configure in such a way that, when the high award symbols W1 are visibly stopped aligned on the pay line L1, in addition to allocating the highest award, a transition is made from a normal gaming mode, in which a normal slot game can be played, to a special gaming mode such as, for example, a free game in which a prescribed number of free spins (an operation in which the reels 5L, 5C and 5R rotate automatically without inserting any coins and stop after an elapsing of a fixed time, and a coin payout is performed in accordance with a combination of stopped symbols) related to the game can be performed. That is, it is also acceptable to configure in such a way that, after the base game process of step 3 shown in FIG. 9 finishes, based on whether or not the code number pattern, in which the high award symbols W1 are visibly stopped aligned on the pay line L1, has been established, the CPU 47 determines whether or not a trigger for the free game is established, and that, when the trigger is established, a transition is made to the special gaming mode. With such a configuration, the player, as well as being able to obtain a high award by the high award symbols being aligned, can enjoy the free game and the like, thus enabling an increase in a gaming thrill by the slot machine 1.

In the embodiment described above, the main display 4 and the reel unit 5 serve as an image display device that has a symbol display area. The SPIN switch 9, the 1-BET switch 10 and the MAX-BET switch 11 serve as an operation unit that allows the player to input operations including the start command to start the game. The control board 41 including the CPU 47 serves as a processor that performs the game process (main process) for providing the player the game by controlling the image display device to display a progress of the game.

The foregoing description of the embodiment has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable those skilled in the art to utilize the invention in various embodiments and with various modifications as are suited to the particular use contemplated. It is intended that the scope of the invention be defined by the claims appended hereto, and their equivalents.

What is claimed is:

1. A gaming machine comprising:
an image display device that has a symbol display area;
an operation unit that allows a player to input operations including a start command to start a game; and
a processor that performs a game process for providing the player the game by controlling the image display device to display a progress of the game, the processor performing the game process comprising:
controlling the image display device to perform variable display for variably displaying a plurality of symbols in a predetermined sequence in the symbol display area when the start command is input through the operation unit;
determining a stop state of the symbol by determining a symbol from among the plurality of symbols to be displayed stopped on a pay line that is configured for determining a win of the game;
controlling the image display device to perform stop display of the determined symbol on the pay line in the stop state; and
performing a payout of an award to the player in accordance with the stop state,
wherein the plurality of symbols include a special display symbol that is to be displayed in a larger size than other symbols by having a central area and two adjacent areas arranged adjacent to the central area, the central area and the adjacent areas being configured to be stoppable on the pay line, and
wherein the processor performs the game process further comprising a two-step visible stopping control for controlling the image display device to perform stop display of the special display symbol when the special display symbol is determined to be displayed stopped on the pay line, by controlling the image display device to perform stop display of the central area on the pay line after controlling the image display device to temporary perform stop display of one of the adjacent areas on the pay line.

2. The gaming machine according to claim 1, wherein the image display device includes a mechanical reel that is arranged with the plurality of symbols in the predetermined sequence on a peripheral surface of the mechanical reel.

3. The gaming machine according to claim 1, further comprising a storage that stores symbol codes that are individually related to each of the plurality of symbols other than the special display symbol, and to the central area and the adjacent areas of the special display symbol,
wherein the processor performs the game process comprising:
selecting one of the symbol codes by a random number selection;
determining the special display symbol as the symbol to be displayed stopped on the pay line when the selected symbol code is related to any one of the central area and the adjacent areas;
controlling the image display device to perform the two-step visible stopping control when the selected symbol code is related to one of the adjacent areas; and
controlling the image display device to perform the stop display of the special display symbol without performing the two-step visible stopping control when the selected symbol code is related to the central area.

4. The gaming machine according to claim 1, wherein the processor performs the two-step visible stopping control by controlling the image display device to perform displacement display for moving one of the adjacent areas being temporary stopped on the pay line so as to eventually display the central area being stopped on the pay line.

5. The gaming machine according to claim 1, wherein the image display device has a plurality of symbol display areas that are arranged on a line, each of the symbol display areas being configured to be performed with the variable display and the stop display by the processor.

6. The gaming machine according to claim 5, wherein the symbol display areas include specific symbol display area in which the determined symbol is displayed stopped latest among the symbol display areas, and
wherein at least the specific symbol display area is configured to be performed with the two-step visible stopping control by the processor.

7. The gaming machine according to claim 6, wherein the symbols display areas are arranged on a row, and
wherein the specific symbol display area is arranged at a rightmost position among the symbol display areas.

8. A gaming machine for allowing a player to play a variable display game based on a variable display and a stop display of a plurality of symbols and paying out an award responsive to the stopped symbol, the gaming machine comprising:
a variable display means for variably displaying a plurality of symbols;
a symbol determination means for determining a stop symbol from among the plurality of symbols to be displayed stopped on an activated pay line to determine a win; and
a symbol display control means for performing stop display of the stop symbol determined by the symbol determination means on the activated pay line,
wherein the plurality of symbols include a special display symbol that is to be displayed in a larger size than other symbols by having a central area and two adjacent areas arranged adjacent to the central area, the central area and the adjacent areas being configured to be stoppable on the pay line, and
wherein, when the special display symbol is determined as the stop symbol by the symbol determination means, the symbol display control means performs a two-step visible stopping control in which the special display symbol is visibly stopped on the activated pay line by the central area being stopped on the activated pay line after a temporary stop is performed in which one of the adjacent areas is stopped on the activated pay line.

9. The gaming machine according to claim 8, further comprising:
a symbol code storage means for storing symbol codes that are individually related to each of the plurality of symbols other than the special display symbol, and to the central area and the adjacent areas of the special display symbol; and
a selection means for selecting one of a plurality of the symbol codes stored in the symbol code storage means by a random number selection,
wherein, when the symbol code selected by the selection means is related to one of the central area and the adjacent areas, the symbol determination means determines the special display symbol as the stop symbol,
wherein when the selected symbol code is related to one of the adjacent areas, the symbol display control means performs the two-step visible stopping control, and
wherein, when the selected symbol code is related to the central area, the symbol display control means performs the stop display of the special display symbol on the activated pay line without performing the two-step visible stopping control.

10. The gaming machine according to claim 8, wherein the symbol display control means performs the two-step visible stopping control by performing displacement display for moving one of the adjacent areas being temporary stopped on the pay line so as to eventually display the central area being stopped on the pay line.

11. The gaming machine according to claim 8, wherein a plurality of symbol columns each having the plurality of symbols to be variably displayed is arranged in a line on the variable display means, and
wherein the symbol display control means performs the two-step visible stopping control in at least a last symbol column, of the plurality of symbol columns, to be displayed stopped latest among the symbol columns.

12. The gaming machine according to claim 11, wherein the plurality of symbol columns are arranged in horizontal side-by-side relation, and the last symbol column is disposed on a rightmost position.
